(19) United States
(12) Patent Application Publication
(10) Pub. No.: US 2026/0220663 A1
(43) Pub. Date: Jul. 30, 2026

(54) REVIEW SUPPORT DEVICE, REVIEW SUPPORT METHOD, AND RECORDING MEDIUM

(71) Applicant: NEC Corporation, Tokyo (JP)

(72) Inventors: Yoshiaki Inoue, Tokyo (JP); Tokiyoshi Kurogi, Tokyo (JP)

(73) Assignee: NEC Corporation, Tokyo (JP)

(21) Appl. No.: 19/457,347

(22) Filed: Jan. 23, 2026

(30) Foreign Application Priority Data
Jan. 30, 2025 (JP) 2025-013939

(51) Int. Cl. G06Q 30/0241; G06Q 30/018

(52) U.S. Cl. CPC G06Q 30/0248; G06Q 30/018

(57) ABSTRACT

In the review support device, the target data acquisition unit acquires target data for review. The non-public information acquisition unit acquires non-public information relevant to the target data. The material type detection unit detects a material type of the target data. The prompt generation unit generates a prompt to be input to a language model, based on the target data, the material type, and the non-public information. The device therefore enables automated decision making by an artificial intelligence (AI) model to efficiently determine compliance of target data.

### INCORPORATION BY REFERENCE

This application is based upon and claims the benefit of priority from Japanese Patent Application 2025-013939, filed on January 30, 2025, the disclosure of which is incorporated herein in its entirety by reference.

### TECHNICAL FIELD

The present disclosure relates to a technique for supporting review by using generative AI.

### BACKGROUND ART

The utilization of a system that generates, by using generative artificial intelligence (AI), an answer based on a directive input by a user is progressing. JP2024-129086A describes a method for generating instruction data for a large model that is a type of generative AI, in which a reference instruction based on a natural language is structurally disassembled, thereby enhancing flexibility of instruction training data generation process and enhancing an instruction compliance capability of the large model.

### SUMMARY

Conventionally, in a case of reviewing whether advertisements and the like displayed on various media conform to legal regulations or voluntary regulations of industry groups, since a person in charge of review who has knowledge performs visual confirmation, there has been a problem that man-hours become enormous and a lead time becomes long.

An object of the present disclosure is to provide, in review of target data, support for reducing a burden on the person in charge of the review and shortening a lead time of the review.

According to an example aspect of the present invention, there is provided a review support device comprising:

a target data acquisition means for acquiring target data for review;

a non-public information acquisition means for acquiring non-public information relevant to the target data;

a material type detection means for detecting a material type of the target data; and

a prompt generation means for generating a prompt to be input to a language model, based on the target data, the material type, and the non-public information.

According to another example aspect of the present invention, there is provided a review support method executed by a review support device, the method comprising:

acquiring target data for review;

acquiring non-public information regarding the target data;

detecting a material type of the target data; and

generating a prompt to be input to a language model, based on the target data, the material type, and the non-public information.

According to still another example aspect of the present invention, there is provided a non-transitory computer-readable recording medium storing a program executed by a computer in a review support device, the program causing the computer to execute processing including:

acquiring target data for review;

acquiring non-public information regarding the target data;

detecting a material type of the target data; and

generating a prompt to be input to a language model, based on the target data, the material type, and the non-public information.

According to the present disclosure, it is possible to provide, in review of target data, support for reducing a burden on a person in charge of the review and shortening a lead time of the review.

### BRIEF DESCRIPTION OF THE DRAWINGS

FIG. 1 illustrates an example of a schematic configuration of a review support system according to the present disclosure;

FIGS. 2A and 2B are block diagrams illustrating examples of hardware configurations of a server and a user terminal;

FIG. 3 is a diagram schematically illustrating processing in the review support system;

FIG. 4 is an example of information that can be acquired by uploading a material;

FIG. 5 is an example of material information;

FIG. 6 is an example of non-public information;

FIG. 7 is an example of an output format;

FIG. 8 is a block diagram illustrating an example of a functional configuration of the server;

FIG. 9 is an example of format conversion of a material type;

FIG. 10 is an example of a directive text pattern;

FIG. 11 is an example of a data structure of a management DB;

FIG. 12 is a flowchart of review support processing;

FIG. 13 is a block diagram illustrating a functional configuration of a review support device; and

FIG. 14 is a flowchart by the review support device.

### EXAMPLE EMBODIMENTS

Preferred example embodiments of the present disclosure will be described with reference to the accompanying drawings.

### First Example Embodiment

### Overall Configuration

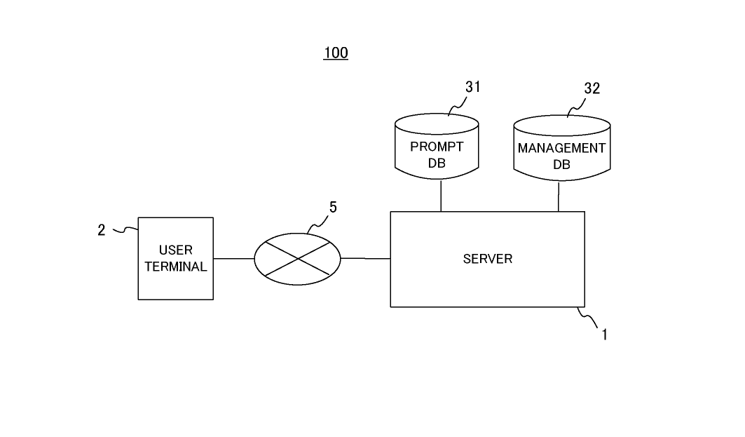

FIG. 1 is an example of a schematic configuration of a review support system 100 to which a review support device of the present disclosure is applied. The review support system 100 is a system that can acquire a result of reviewing target data without requiring a user to input a directive text. Here, the user is, for example, a person in charge of review who reviews the target data. The target data is data such as advertisements and broadcast shows displayed on various media, and is also referred to as a "material" in the present disclosure. The review is to check whether the advertisements and the broadcast shows comply with legal regulations, voluntary regulations of industry groups, and examination standards of media. In this manner, by reviewing the target data, it is possible to ensure soundness of the advertisements and the broadcast shows displayed on the various media.

Advertisements using the Internet as a medium are expected to grow in the future, and a market size is also expanding. However, with an increase in advertisements using the Internet as the medium including social networking services (SNSs), there have been many social problems due to haphazard review. In response to this situation, the government is also promoting a policy to reinforce regulations on advertisement content as needed. Therefore, there is an increasing demand for easily and appropriately reviewing advertisements and shows displayed not only on the Internet but also on various media such as televisions and magazines.

According to the review support system 100, the user does not need to input a directive text that is difficult for a person with little knowledge of the generative AI, and can easily review the target data by using the generative AI. In addition, according to the review support system 100, by using the generative AI for the review of the target data, it is possible to provide support for reducing a burden on the person in charge of the review and shortening a lead time of the review.

In the review support system 100 of FIG. 1, a server 1 and a user terminal 2 are communicably connected via a network 5 such as the Internet. In addition, the server 1 is connected to a prompt database (Hereinafter, a "database" is referred to as a "DB") 31 and a management DB 32.

In the review support system 100 of FIG. 1, the server 1 and the user terminal 2 are communicably connected via the network 5 such as the Internet. The user terminal 2 is a tablet, a PC, or the like used by a user who reviews target data. The user terminal 2 transmits, to the server 1, materials that are registered by the user via an input screen and are to be reviewed and information regarding output formats and the like of the materials and results, receives a result of reviewing the materials from the server 1, and displays the result.

The server 1 is an information processing device that processes, stores, and transmits/receives various kinds of data, and receives, from the user terminal 2, the materials to be reviewed and the information regarding the output formats and the like of the materials and the results. Also, the server 1 transmits, to the user terminal 2, a review result acquired by inputting a prompt generated based on the received information to the generative AI. As an example, the generative AI is a language model such as a natural language model or a large language model (LLM) capable of understanding multimodal information. Furthermore, the server 1 may be a virtual server in a cloud environment. The server 1 is an example of the review support device of the present disclosure.

### Hardware Configuration

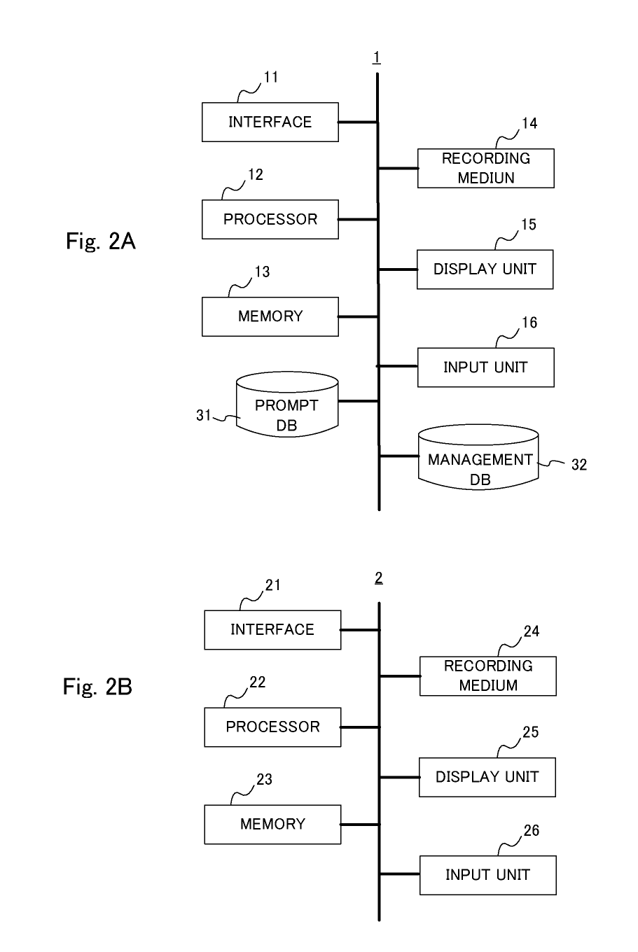

FIG. 2A is a block diagram illustrating an example of a hardware configuration of the server 1. As illustrated in FIG. 2A, the server 1 includes an interface 11, a processor 12, a memory 13, a recording medium 14, a display unit 15, and an input unit 16. These constituent elements, the prompt DB 31, and the management DB 32 are connected to each other via a bus.

The interface 11 exchanges data with the user terminal 2. The interface 11 receives, from the user terminal 2, a material to be reviewed, and information regarding an output format and the like of the material and a result, and transmits a result of the review.

The processor 12 is a computer such as a Central Processing Unit (CPU), and controls the entire server 1 by executing a program prepared in advance. As the processor 12, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like can be used.

The memory 13 includes a read only memory (ROM), a random access memory (RAM), and the like. The memory 13 stores a program executed by the processor 12. The memory 13 is also used as a work memory during execution of various types of processing by the processor 12.

The recording medium 14 is a non-volatile non-transitory recording medium such as a disk-shaped recording medium or a semiconductor memory, and is attachable to and detachable from the server 1. The recording medium 14 records various programs to be executed by the processor 12. When the server 1 executes review support processing, the program recorded in the recording medium 14 is loaded into the memory 13 and executed by the processor 12.

The display unit 15 displays a predetermined image by, for example, a liquid crystal display (LCD). The input unit 16 is a keyboard, a mouse, a touch panel, or the like, and is used by an operator who manages the server 1.

The prompt DB 31 stores a directive text pattern that is a form of a directive text requesting review of a material. Although details will be described later, a plurality of directive text patterns may be stored according to a material type, a perspective of the review, and the like. The server 1 generates the directive text by applying information extracted from the material type, material information, and the output format registered by the user to the directive text pattern.

The management DB 32 stores and manages the directive text to the LLM and a result output by the LLM by the input of the prompt including the directive text in association with each other. Although details will be described later, the management DB 32 may manage the material type, the material information, and the like in association with each other. The management DB 32 may generate the directive text based on the information regarding the material, and may store and manage a series of data until LLM outputs the result of reviewing the material by the input of the prompt including the directive text. The "directive text" is a sentence indicating processing to be executed by the LLM. In addition, the "prompt" includes the directive text and the material, and is data input to the LLM.

FIG. 2B is a block diagram illustrating an example of a hardware configuration of the user terminal 2. As illustrated in FIG. 2B, the user terminal 2 includes an interface 21, a processor 22, a memory 23, a recording medium 24, a display unit 25, and an input unit 26.

The interface 21 exchanges data with the server 1 via the network 5. The interface 21 transmits, to the server 1, a material to be reviewed, and information regarding an output format and the like of the material and a result, and receives a result of reviewing the material from the server 1.

The processor 22 is a computer such as a CPU, and controls the entire user terminal 2 by executing a program prepared in advance. As the processor 22, it is possible to use a CPU, a GPU, a DSP, an MPU, an FPU, a PPU, a TPU, a quantum processor, a microcontroller, a combination of these, or the like.

The memory 23 includes a ROM and a RAM. The memory 23 stores a program executed by the processor 22. The memory 23 is also used as a work memory during execution of various types of processing by the processor 22.

The recording medium 24 is a non-volatile non-transitory recording medium such as a disk-shaped recording medium or a semiconductor memory, and is attachable to and detachable from the user terminal 2. The recording medium 24 records various programs to be executed by the processor 22. The display unit 25 displays a predetermined image by, for example, an LCD. The input unit 26 is a touch panel or the like, and is used when the user performs a predetermined operation.

### Processing in Review Support System

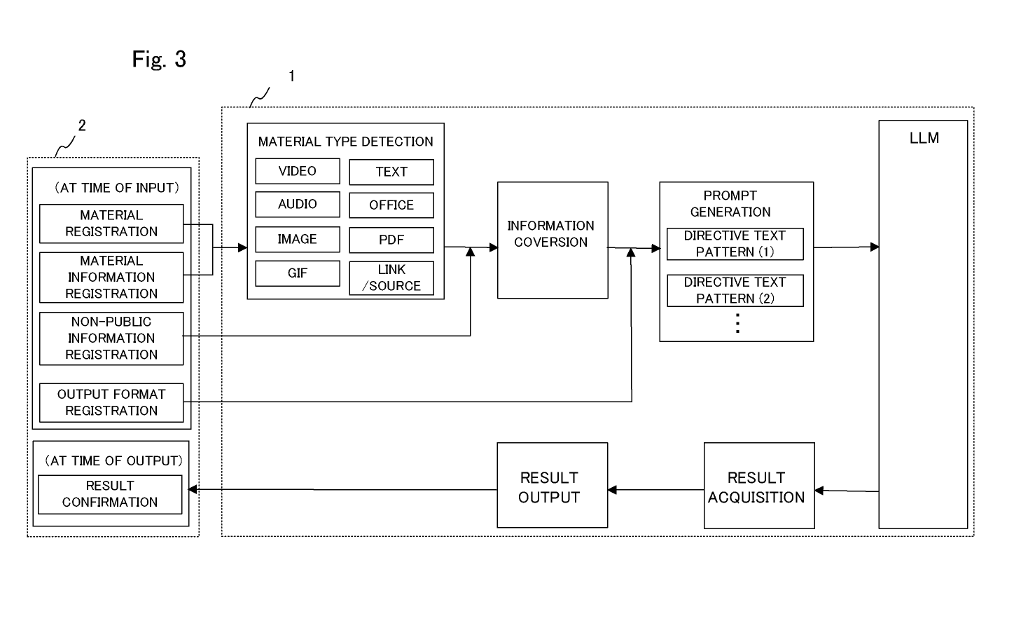

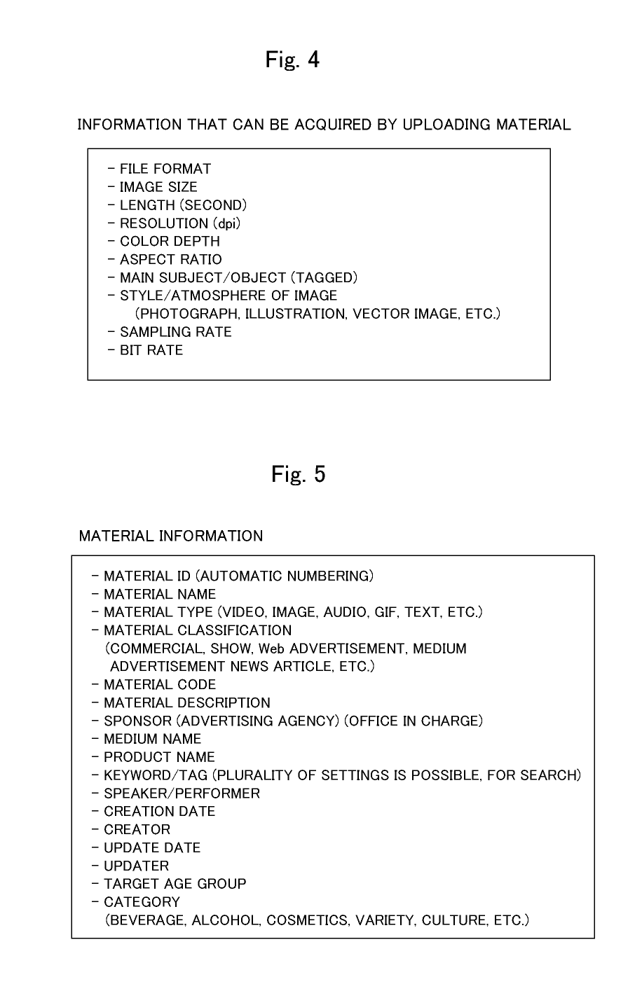

FIG. 3 is a diagram schematically illustrating processing in the review support system 100. As illustrated in FIG. 3, the user terminal 2 performs material registration, material information registration, non-public information registration, and output format registration at a time of inputting target data, and confirms a result at a time of outputting the result. The material registration is registration of a material to be the target data, and the user uploads the material to be reviewed on the input screen. FIG. 4 is an example of information that can be acquired by uploading the material. As illustrated in FIG. 4, for example, the user terminal 2 can acquire a file format, an image size, a length (second), a resolution (dpi), a color depth, an aspect ratio, a tagged main subject or object, a style or atmosphere of an image such as a photograph or an illustration, a sampling rate, a bit rate, and the like according to the uploaded material.

The material information registration is registration of the information regarding the material, and the user optionally registers various kinds of information regarding the material on the input screen. FIG. 5 is an example of the material information. As illustrated in FIG. 5, the user registers the material information by selecting or inputting a material name, a material type, a material classification, a material code, a material description, a sponsor and an advertising agency, a medium name, a product name, a keyword or a tag, a speaker or a performer, a creation date, a creator, an update date, an updater, a target age group, and a category, according to the material on the input screen. The material information is not limited to the example illustrated in FIG. 5, and can be optionally set to a campaign industry type, a campaign content, a campaign period, an appealing merchandise, and the like. In addition, the material information may be designed to be registerable by the user selecting information automatically detected at a stage where the material is uploaded or performing an optional input on the input screen.

A material ID for identifying the material is assigned by automatic numbering, and is registered as part of the material information. The material type is a type of material, and examples thereof include a video, an image, audio, graphics interchange format (GIF), text, Word and Excel included in Microsoft Office, portable document format (PDF), and a predetermined link and source. The material classification is a classification of the material, and examples thereof include a commercial, a show, a Web advertisement, a medium advertisement, a news article, a radio sound source, a script, a storyboard, and the like. The category is a category included in the material, and includes a category to which an advertisement such as a beverage, alcohol, or cosmetics belongs, a category to which a show such as variety or culture belongs, and the like.

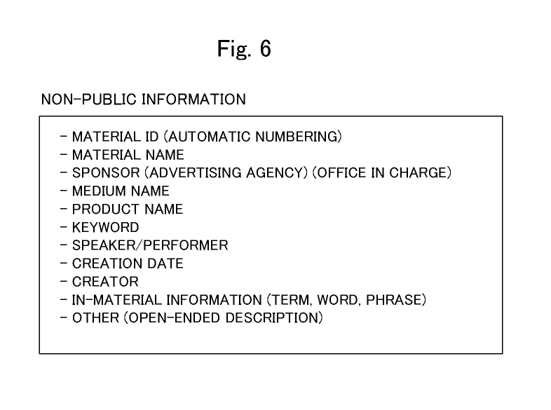

The non-public information registration is registration of the non-public information, and the user optionally registers various kinds of information to be non-public on the input screen. The non-public information refers to information that is not desired to be learned by the LLM used for the review, in other words, information that is not desired to be input to the LLM. FIG. 6 is an example of the non-public information. As illustrated in FIG. 6, the user registers the non-public information by inputting, on the input screen, a material name, a sponsor and an advertising agency, a medium name, a product name, a keyword, a speaker or a performer, a creation date, a creator, a word or a phrase included in the material, and the like that are desired to be non-public according to the material. Specifically, for example, in a case where the material classification is a commercial and it is desired to prevent leakage of information on a performer before broadcasting of the commercial, the user registers the performer in the non-public information. The non-public information may be designed to be registerable by the user selecting, on the input screen, the information automatically detected at the stage where the material is uploaded or information reflected at the time of registering the material information.

The material ID for identifying the material is assigned by automatic numbering, and is registered as part of the non-public information.

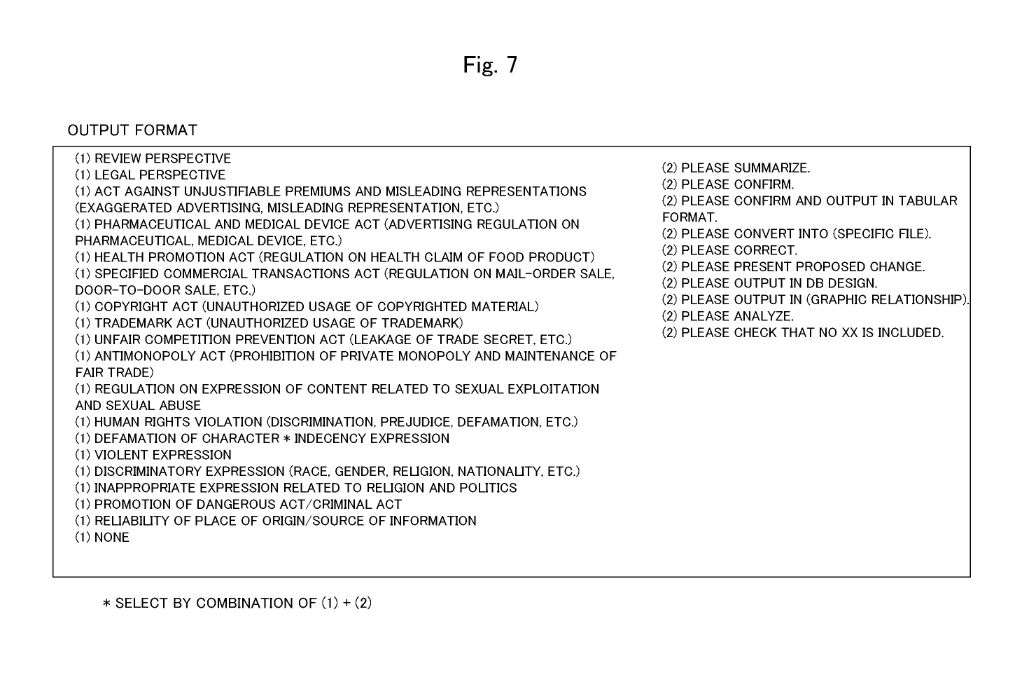

The output format registration is registration of an output format of a result by the LLM, and the user registers an output format indicating what type of result is desired to be output by selecting or inputting the output format on the input screen. FIG. 7 is an example of the output format. The output format is composed of two aspects that are from which perspective the material is reviewed and how the result of the review is output, and the user registers the output format by selecting and combining options displayed on the input screen.

As illustrated in FIG. 7, the options for from which perspective the material is reviewed include, for example, review perspective, legal perspective, Act against Unjustifiable Premiums and Misleading Representations, Pharmaceutical and Medical Device Act, Health Promotion Act, Specified Commercial Transactions Act, Copyright Act, Trademark Act, Unfair Competition Prevention Act, Antimonopoly Act, regulation on expression of content related to sexual exploitation and sexual abuse, human rights violation, defamation of character/indecency expression, violent expression, discriminatory expression, inappropriate expression related to religion and politics, promotion of dangerous act/criminal act, and reliability of place of origin and source of information. Here, the "review perspective" indicates that the material is reviewed comprehensively, and the "legal perspective" indicates that the material is reviewed whether it complies with legal regulations. The specific act name indicates that the material is reviewed whether it complies with the regulations of the act, and the others such as the "discriminatory expression" indicate that the material is reviewed whether there is a problem from the perspective of the discriminatory expression. Note that from which perspective the material is reviewed is not limited to one option, but may be selected from the plurality of options.

As illustrated in FIG. 7, the options for how the result of the review is output include, for example, please summarize, please confirm, please confirm and output in tabular format, please convert into specific file, please correct, please present proposed change, please output in DB design, please output in graphic relationship, please analyze, and please check that no xx is included. Note that how the result of the review is output is not limited to one option, but may be selected from the plurality of options.

For example, in a case where, on the input screen by using the user terminal 2, the user selects "inappropriate expression related to religion and politics" for from which perspective the material is reviewed and selects "please confirm and output in tabular format" for how the result of the review is output, the output format is "please confirm and output inappropriate expression related to religion and politics in tabular format". In this case, the user can acquire the result of confirming the material from the perspective of inappropriate expression related to religion and politics in tabular format. In addition, for example, in a case where the user selects "none" for from which perspective the material is reviewed and "please summarize" for how the result of the review is output on the input screen, the output format is "please summarize". In this case, the user can acquire a result of summarizing the material.

In addition, for example, in a case where the user selects "Pharmaceutical and Medical Device Act" and "Health Promotion Act" for from which perspective the material is reviewed and "please confirm" for how the result of the review is output on the input screen, the output format is "please confirm from the perspective of Pharmaceutical and Medical Device Act and Health Promotion Act". In this case, the user can acquire a result of confirming the material from the perspective of Pharmaceutical and Medical Device Act and Health Promotion Act. In addition, for example, in a case where the user selects "violent expression" for from which perspective the material is reviewed and "please check whether something is included" and "please present proposed change" for how the result of the review is output on the input screen, the output format is "please check that no violent expression is included and please present proposed change". In this case, the user can check that no violent expression is included, and if the violent expression is included, the user can acquire a result of presenting the proposed change of the violent expression. Note that the user may select the plurality of options for each of from which perspective the material is reviewed and how the result of the review is output.

As illustrated in FIG. 3, the server 1 performs material type detection, information conversion, and prompt generation, and inputs the generated prompt to the LLM. Next, the server 1 performs result acquisition and result output, acquires a result output by the LLM, and transmits the result as the result of reviewing the material to the user terminal 2. Details will be described in the following functional configuration.

### Functional Configuration

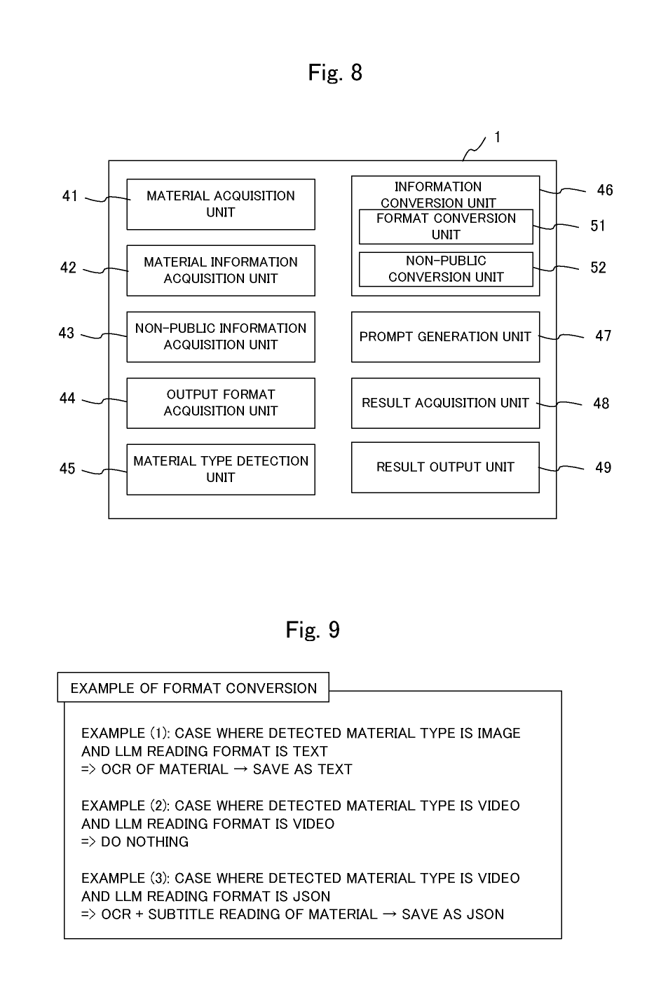

FIG. 8 is a block diagram illustrating an example of a functional configuration of the server 1. The server 1 functionally includes a material acquisition unit 41, a material information acquisition unit 42, a non-public information acquisition unit 43, an output format acquisition unit 44, a material type detection unit 45, an information conversion unit 46, a prompt generation unit 47, a result acquisition unit 48, and a result output unit 49.

The material acquisition unit 41, the material information acquisition unit 42, the non-public information acquisition unit 43, the output format acquisition unit 44, the material type detection unit 45, the information conversion unit 46, the prompt generation unit 47, the result acquisition unit 48, and the result output unit 49 are implemented by the processor 12 executing a program.

The material acquisition unit 41 acquires a material to be reviewed from the user terminal 2.

The material information acquisition unit 42 acquires material information regarding the material from the user terminal 2.

The non-public information acquisition unit 43 acquires, from the user terminal 2, non-public information that is not desired to be learned by the LLM used for the review.

The output format acquisition unit 44 acquires an output format of a result by the LLM from the user terminal 2.

The material type detection unit 45 detects a material type from information that can be acquired from an uploaded material and the material information. Specifically, the material type detection unit 45 detects the material type by reading an extension or the like of the material.

The information conversion unit 46 converts the material into information readable by the LLM, based on the material type and the non-public information. The information conversion unit 46 includes a format conversion unit 51 and a non-public conversion unit 52.

The format conversion unit 51 converts the material type of the material into a format readable by the LLM. FIG. 9 illustrates an example of format conversion. As in the example illustrated in FIG. 9, in a case where the detected material type is "image" and the LLM reading format is "text", the format conversion unit 51 converts the image as the material into text by optical character recognition (OCR) and saves the text. As in another example illustrated in FIG. 9, in a case where the detected material type is "video" and the LLM reading format is "video", the format conversion unit 51 does not execute the process of converting the material. As in still another example illustrated in FIG. 9, in a case where the detected material type is "video" and the LLM reading format is "Java Script Object Notation (JSON)", the format conversion unit 51 converts the video as the material into JSON by character recognition and subtitle reading by OCR, and saves the JSON.

The non-public conversion unit 52 converts the information that is included in the material and is not desired to be learned by the LLM into other information, based on the non-public information. For example, in a case where a material has the material type of text and the material classification of a commercial script, and the non-public information is the performer "Taro Yamada", the non-public conversion unit 52 determines whether a character string "Taro Yamada" is included in the text that is the material. If the character string "Taro Yamada" is not included in the text, the non-public conversion unit 52 does not execute the process of converting the material. On the other hand, if the character string "Taro Yamada" is included in the text, the non-public conversion unit 52 executes the process of converting "Taro Yamada" included in the material into a hidden text such as "××××" or another character string.

If the material has undergone the format conversion, the non-public conversion unit 52 executes the conversion process according to the non-public information based on the material after the format conversion.

The prompt generation unit 47 generates a prompt for the LLM based on the material, the material type, the non-public information, the output format, and the like. Specifically, the prompt generation unit 47 selects a directive text pattern from the prompt DB 31 based on the material, the material type, the non-public information, the output format, and the like, and generates the directive text by applying information extracted from the material type, the material information, and the output format to a directive text pattern. Next, the prompt generation unit 47 generates a

prompt including the generated directive text and the material after the format conversion and/or the non-public conversion.

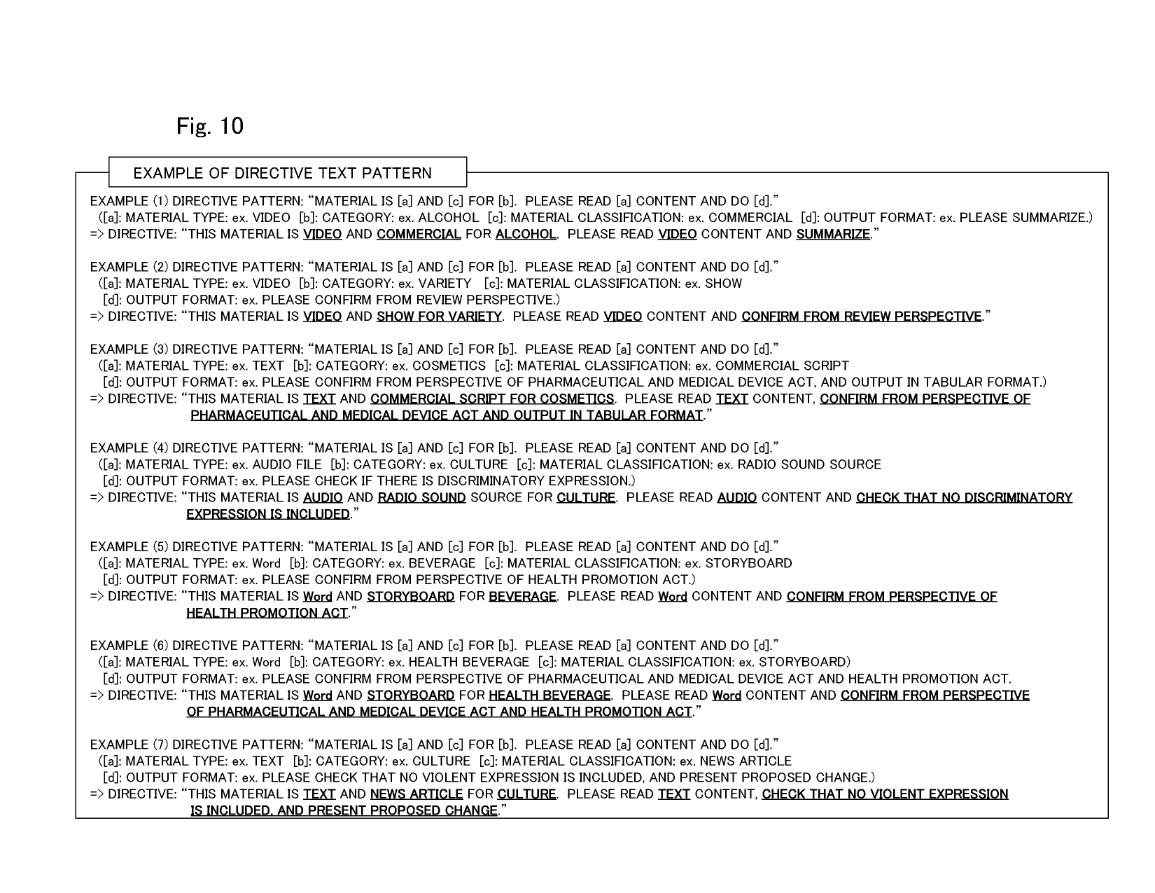

FIG. 10 illustrates examples of the directive text pattern. As illustrated in FIG. 10, an example of the directive text pattern is "Material is [a] and [c] for [b]. Please read [a] content and do [d].", and the directive text is generated by applying the material type to [a], the category to [b], the material classification to [c], and the output format to [d]. Specifically, if the material type of the material to be reviewed is "video", the category is "alcohol", the material classification is "commercial", and the output format is "please summarize", the prompt generation unit 47 generates a directive text that "This material is video and commercial for alcohol. Please read video content and summarize.".

In another example of the directive text generation based on the directive text pattern, as illustrated in FIG. 10, if the material type of the material to be reviewed is "video", the category is "variety", the material classification is "show", and the output format is "please confirm from review perspective", the prompt generation unit 47 generates a directive text that "This material is video and show for variety. Please read video content and confirm from review perspective.".

In still another example of the directive text generation based on the directive text pattern, as illustrated in FIG. 10, if the material type of the material to be reviewed is "text", the category is "cosmetics", the material classification is "commercial script", and the output format is "please confirm from perspective of Pharmaceutical and Medical Device Act and output in tabular format", the prompt generation unit 47 generates a directive text that "This material is text and commercial script for cosmetics. Please read text content, confirm from perspective of Pharmaceutical and Medical Device Act, and output in tabular format.".

In yet another example of the directive text generation based on the directive text pattern, as illustrated in FIG. 10, if the material type of the material to be reviewed is "audio", the category is "culture", the material classification is "radio sound source", and the output format is "please check that no discriminatory expression is included", the prompt generation unit 47 generates a directive text that "This material is audio and radio sound source for culture. Please read audio content and check that no discriminatory expression is included.".

In yet another example of the directive text generation based on the directive text pattern, as illustrated in FIG. 10, if the material type of the material to be reviewed is "Word", the category is "beverage", the material classification is "storyboard", and the output format is "please confirm from perspective of Health Promotion Act", the prompt generation unit 47 generates a directive text that "This material is Word and storyboard for beverage. Please read Word content and confirm from perspective of Health Promotion Act.".

In yet another example of the directive text generation based on the directive text pattern, as illustrated in FIG. 10, if the material type of the material to be reviewed is "Word", the category is "healthy beverage", the material classification is "storyboard", and the output format is "please confirm from perspective of Pharmaceutical and Medical Device Act and Health Promotion Act", the prompt generation unit 47 generates a directive text that "This material is Word and storyboard for healthy beverage. Please read Word content and confirm from perspective of Pharmaceutical and Medical Device Act and Health Promotion Act.".

In yet another example of the directive text generation based on the directive text pattern, as illustrated in FIG. 10, if the material type of the material to be reviewed is "text", the category is "culture", the material classification is "news article", and the output format is "please check that no violent expression is included, and present proposed change", the prompt generation unit 47 generates a directive text that "This material is text and news article for culture. Please read text content, check that no violent expression is included, and present proposed change.".

The result acquisition unit 48 inputs the prompt to the LLM and acquires the result of reviewing the material output from the LLM. The result acquisition unit 48 acquires a result that "This material is ○○." by inputting, to the LLM, a prompt including a predetermined material and a directive text that "This material is video and commercial for alcohol. Please read video content and summarize.", for example.

In addition, the result acquisition unit 48 stores and manages the directive text and the result output by the LLM by the input of the prompt including the directive text in association with each other in the management DB 32. At this time, the result acquisition unit 48 may store and manage the material type, the material information, and the like in association with the directive text pattern, instead of the directive text.

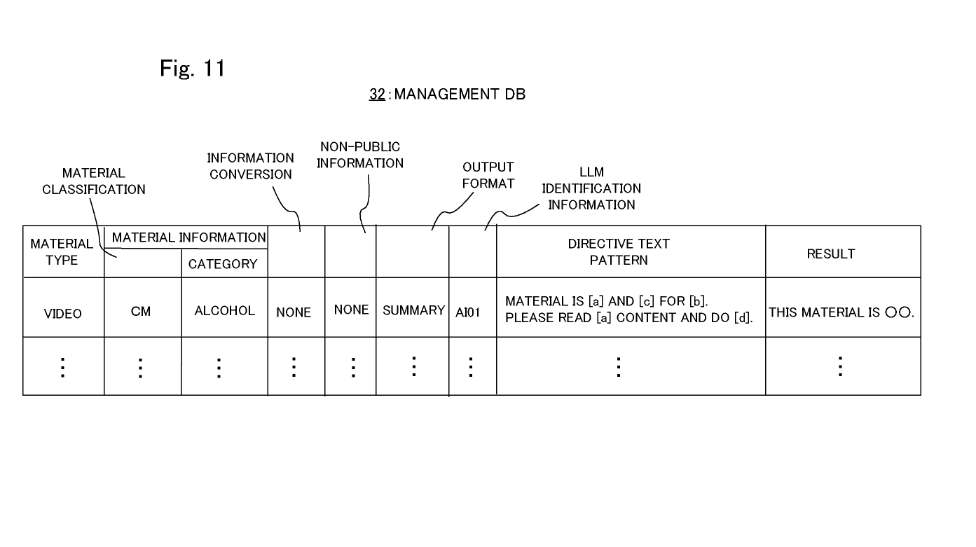

FIG. 11 illustrates an example of a data structure of the management DB 32. As illustrated in FIG. 11, the management DB 32 may store a material type, material information, presence or absence of information conversion, presence or absence of non-public information, an output format, identification information of the LLM, a directive text pattern, and a result in association with each other. The identification information of the LLM is information for identifying the LLM to which the prompt is input, and may be information indicating the type of LLM such as Gemini and ChatGPT.

The prompt generation unit 47 may refer to the management DB 32 based on the material, the material type, the non-public information, the output format, and the like, and select the directive text pattern from the prompt DB 31 in consideration of the past directive text and a result thereof.

The result output unit 49 transmits the result of reviewing the material to the user terminal 2.

In the present disclosure, the generative AI used for the review of the material is the LLM, but the present disclosure is not limited thereto, and any generative AI suitable for the review can be applied according to the material type, the material information, the output format, and the like. In addition, the generative AI suitable for the review may be selected or customized with reference to the management DB 32.

In the above configuration, the material acquisition unit 41, the material information acquisition unit 42, the non-public information acquisition unit 43, the output format acquisition unit 44, the material type detection unit 45, the prompt generation unit 47, the format conversion unit 51, and the non-public conversion unit 52 of the server 1 are examples of a target data acquisition means, a material information acquisition means, a non-public information acquisition means, an output format acquisition means, a material type detection means, a prompt generation means, a format conversion means, and a non-public conversion means of the present disclosure, respectively. In addition, the result acquisition unit 48 and the result output unit 49 of the server 1 are examples of a result acquisition means of the present disclosure, and the prompt DB 31 and the management DB 32 are examples of a prompt storage unit and a management storage unit of the present disclosure, respectively.

### Review Support Processing

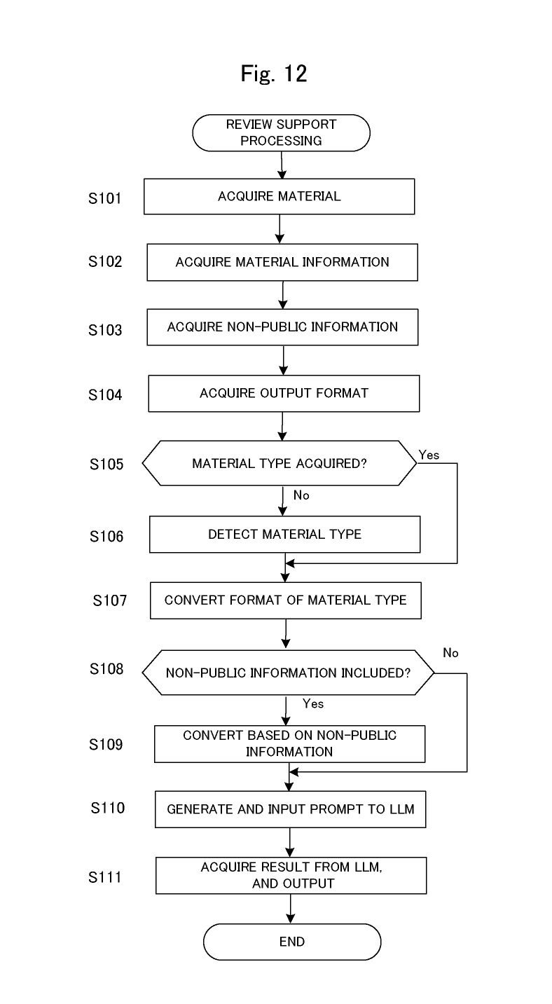

Next, review support processing by the server 1 will be described. FIG. 12 is a flowchart illustrating an example of the review support processing by the server 1. This processing is implemented by the processor 12 illustrated in FIG. 2A executing a program prepared in advance.

The user uploads a material desired to be reviewed on the input screen displayed on the user terminal 2. Next, the user registers, on the input screen, material information regarding the material, non-public information that is not desired to be learned by the LLM used for the review, and an output format of a result by the LLM by using the user terminal 2.

First, the server 1 acquires the material to be reviewed from the user terminal 2 (step S101). Next, the server 1 acquires the material information from the user terminal 2 (step S102). Further, the server 1 acquires the non-public information that is not desired to be learned by the LLM used for the review (step S103). Furthermore, the server 1 acquires the output format of the result by the LLM from the user terminal 2 (step S104).

Next, the server 1 determines whether the material type has been registered as the material information, in other words, whether the material type has been acquired as the material information (step S105). If the material type has been acquired (step S105; Yes), the server 1 proceeds to the process of step S107. On the other hand, if the material type has not been acquired (step S105; No), the server 1 detects the material type from the information that can be acquired from the uploaded material and the material information (step S106).

Next, the server 1 converts the material type of the material into a format readable by the LLM (step S107). The server 1 determines whether the material after the format conversion of the material type includes the non-public information (step S108). If the non-public information is not included (step S108; No), the server 1 proceeds to the process of step S110. On the other hand, if the non-public information is included (step S108; Yes), the server 1 converts the information that is included in the material and is not desired to be learned by the LLM into other information, based on the non-public information (step S109).

Next, the server 1 generates a prompt based on the material, the material type, the non-public information, the output format, and the like, and inputs the prompt to the LLM (step S110). Specifically, the server 1 selects a directive text pattern from the prompt DB 31 based on the material, the material type, the non-public information, the output format, and the like, and generates a directive text by applying information extracted from the material type, the material information, and the output format to the directive text pattern. The server 1 generates a prompt including the generated directive text and the material after the information conversion, and inputs the prompt to the LLM.

Next, the server 1 acquires a result of reviewing the material from the LLM and transmits the result to the user terminal 2 (step S111). At this time, the server 1 stores and manages the directive text and the result output by the LLM in response to the input of the prompt including the directive text in association with each other in the management DB 32. Then, the review support processing ends. The user terminal 2 displays the result of reviewing the material, allowing the user to confirm the result.

According to the review support system 100, it is possible to review target data by using the generative AI without requiring the user to input the directive text. Further, since the review support system 100 automatically converts the material type of the target data into the material type readable by the LLM, it is possible to greatly reduce a burden on a person in charge of review who has little knowledge about the generative AI. Furthermore, since the review support system 100 automatically converts information that is included in the target data and is desired to be non-public into other information, a risk of information leakage can be reduced. In addition, the review support system 100 can easily generate an appropriate directive text and a prompt including the directive text by applying the information extracted from the material type, the material information, and the output format to the directive text pattern based on the registered content of the user. That is, according to the review support system 100, it is possible to easily generate the prompt necessary for the review using the generative AI only by registering the information regarding the target data and the desired output format by the user. Therefore, it is possible to provide, in review of the target data, support for reducing the burden on the person in charge of the review and shortening a lead time of the review.

### Modified Example

In the above example embodiment, the user uses the user terminal 2, but the present disclosure is not limited thereto, and the user may use a user terminal having a function of the server 1. In this case, the user terminal executes the review support processing executed by the server 1, and supports the user to easily and appropriately review a material by using the generative AI.

### Second Example Embodiment

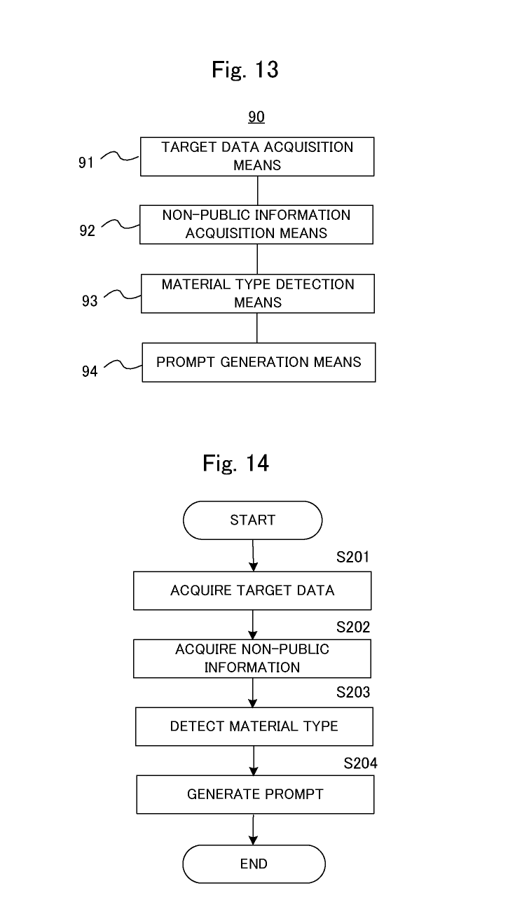

FIG. 13 is a block diagram illustrating an example of a functional configuration of a review support device of the present disclosure. A review support device 90 includes a target data acquisition means 91, a non-public information acquisition means 92, a material type detection means 93, and a prompt generation means 94.

FIG. 14 is a flowchart illustrating an example of processing by the review support device 90. The target data acquisition means 91 acquires target data for review (step S201). The non-public information acquisition means 92 acquires non-public information relevant to the target data (step S202). The material type detection means 93 detects a material type of the target data (step S203). The prompt generation means 94 generates a prompt to be input to a language model, based on the target data, the material type, and the non-public information (step S204). According to the review support device 90, it is possible to easily generate the prompt necessary for the review using the language model based on the acquired target data and non-public information. Therefore, it is possible to provide, in review of the target data, support for reducing the burden on the person in charge of the review and shortening a lead time of the review.

A part or all of the example embodiments including modified examples described above may also be described as the following supplementary notes, but not limited thereto.

### Supplementary note 1

A review support device comprising:

a target data acquisition means for acquiring target data for review;

a non-public information acquisition means for acquiring non-public information relevant to the target data;

a material type detection means for detecting a material type of the target data; and

a prompt generation means for generating a prompt to be input to a language model, based on the target data, the material type, and the non-public information.

### Supplementary note 2

The review support device according to Supplementary note 1, further comprising a format conversion means for converting the target data into a material type readable by the language model.

### Supplementary note 3

The review support device according to Supplementary note 1, further comprising a non-public conversion means for converting information that is included in the target data and is not desired to be input to the language model into other information, based on the non-public information.

### Supplementary note 4

The review support device according to Supplementary note 1, further comprising;

a result acquisition means for acquiring and outputting a result output by the language model to which the prompt is input; and

an output format acquisition means for acquiring an output format of the result,

wherein the prompt generation means generates the prompt to be input to the language model, based on the target data, the material type, and the output format.

### Supplementary note 5

The review support device according to Supplementary note 4, further comprising a material information acquisition means for acquiring material information regarding the target data,

wherein the prompt generation means generates a prompt to be input to the language model based on the target data, the material type, the output format, and the material information.

### Supplementary note 6

The review support device according to Supplementary note 5, further comprising a prompt storage for storing a directive text pattern that is a form of the directive text included in the prompt,

wherein the prompt generation means generates a prompt including a directive text and the target data,

wherein the directive text is generated by applying the material type, the material information and information extracted from the output format to the directive text pattern.

### Supplementary note 7

The review support device according to Supplementary note 6, further comprising a management storage for storing the directive text and a result output by the language model in response to an input of the prompt including the directive text in association with each other,

wherein the prompt generation means generates the prompt with reference to the management storage.

### Supplementary note 8

The review support device according to Supplementary note 1, wherein the prompt generation means generates a prompt requesting a result of reviewing whether the target data complies with at least one of a legal regulation, a voluntary regulation of an industry group, and examination of a medium.

### Supplementary note 9

A review support method executed by a review support device, the method comprising:

acquiring target data for review;

acquiring non-public information relevant to the target data;

detecting a material type of the target data; and

generating a prompt to be input to a language model, based on the target data, the material type, and the non-public information.

### Supplementary note 10

A non-transitory computer-readable recording medium storing a program executed by a computer in a review support device, the program causing the computer to execute processing including:

acquiring target data for review;

acquiring non-public information relevant to the target data;

detecting a material type of the target data; and

generating a prompt to be input to a language model, based on the target data, the material type, and the non-public information.

Some or all of the configurations described in Supplementary Notes 2 to 8 dependent on the above-described Supplementary Note 1 can also be dependent on Supplementary Notes 9 and 10 by a dependency relationship similar to that of Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure. In other words, the present disclosure naturally includes various modifications and alterations that a person skilled in the art would be able to make in accordance with the entire disclosure, including the scope of the claims, and the technical ideas.

### DESCRIPTION OF SYMBOLS

1 Server

2 User terminal

31 Prompt DB

32 Management DB

41 Material acquisition unit

42 Material information acquisition unit

43 Non-public information acquisition unit

44 Output format acquisition unit

45 Material type detection unit

46 Information conversion unit

47 Prompt generation unit

48 Result acquisition unit

49 Result output unit

100 Review support system

1. A review support device comprising:
a memory configured to store instructions; and
a processor configured to execute the instructions to:
acquire target data for review;
acquire non-public information relevant to the target data;
detect a material type of the target data; and
generate a prompt to be input to a language model, based on the target data, the material type, and the non-public information.

2. The review support device according to claim 1, wherein the processor is further configured to execute the instructions to convert the target data into a material type readable by the language model.

3. The review support device according to claim 1, wherein the processor is further configured to execute the instructions to convert information that is included in the target data and is not desired to be input to the language model into other information, based on the non-public information.

4. The review support device according to claim 1,
wherein the processor is further configured to execute the instructions to:
acquire and output a result output by the language model to which the prompt is input; and
acquire an output format of the result, and
wherein the processor generates the prompt to be input to the language model, based on the target data, the material type, and the output format.

5. The review support device according to claim 4,
wherein the processor is further configured to execute the instructions to acquire material information relevant to the target data, and
wherein the processor generates a prompt to be input to the language model based on the target data, the material type, the output format, and the material information.

6. The review support device according to claim 5, further comprising a prompt storage configured to store a directive text pattern that is a form of the directive text included in the prompt,
wherein the processor generates a prompt including a directive text and the target data, and
wherein the directive text is generated by applying the material type, the material information and information extracted from the output format to the directive text pattern.

7. The review support device according to claim 6, further comprising a management storage configured to store the directive text and a result output by the language model in response to an input of the prompt including the directive text in association with each other,
wherein the processor generates the prompt with reference to the management storage.

8. The review support device according to claim 1, wherein the processor generates a prompt requesting a result of reviewing whether the target data complies with at least one of a legal regulation, a voluntary regulation of an industry group, and examination of a medium.

9. A review support method executed by a review support device, the method comprising:
acquiring target data for review;
acquiring non-public information relevant to the target data;
detecting a material type of the target data; and
generating a prompt to be input to a language model, based on the target data, the material type, and the non-public information.

10. A non-transitory computer-readable recording medium storing a program executed by a computer in a review support device, the program causing the computer to execute processing including:
acquiring target data for review;
acquiring non-public information relevant to the target data;
detecting a material type of the target data; and
generating a prompt to be input to a language model, based on the target data, the material type, and the non-public information.
